(19) United States
(12) Patent Application Publication
(10) Pub. No.: US 2004/0004376 A1
(43) Pub. Date: Jan. 8, 2004

(54) Enhanced ticket sales

(76) Inventor: Jayson G. Cabebe, Diamond Bar, CA (US)

Correspondence Address: Maria Erlinda C. Sarno, Esq., P.O. Box 1023, Artesia, CA, 90702, US

(21) Appl. No.: 10/189,994

(22) Filed: Jul. 5, 2002

(51) Int. Cl. A61H 23/02; A47C 31/12

(52) U.S. Cl. 297/217.1; 601/98; 601/49; 601/101

(57) ABSTRACT

This invention provides a method for enhancing ticket sales in theaters by installing massage chairs instead of conventional chairs to enable the viewer or patron to tone its mind and body while watching a performance. Increase in revenue is through increase in attendance and or increase in pricing. In a theater setting where not all of the chairs are replaced by massage chairs, the massage chairs are equipped with certain features and certain procedures for access and activation are placed to ensure that only patrons who paid at a premium can use the massage chairs.

### BACKGROUND

Some theaters today have lost revenues due to the introduction and popularity of home video recorders that could play recorded movies and performances. Home viewers is used herein to refer to viewers that prefer to see a movie or a recorded performance, exhibit, lecture, etc. played on Video Cassette Recorders or Digital Video Disk Players in the comfort of a home setting where one can be in any attire and can assume any position, sitting down, lying down, etc. Recorded videos are also popular because it allows one to stop, pause, replay, play a recording at will and for those who can not wait what happens at the end, can play the end before the beginning. To counter this, theaters today offer greater comfort to patrons such as providing softer cushioned chairs, wider chairs, reclining seats, advanced reservations, guaranteed seating, lounge areas, exclusive viewing rooms, game rooms, wider screens, better acoustics and sound systems, and the like as an enticement. Further, theater owners demand delay distribution of new movies and performances on VHS or DVD recorded tapes/disks to avoid competition and of course, less revenue. However, since these recorded performances eventually become available albeit in a later time, some home viewers would rather wait than give up the comfort associated with home viewing.

A means for enhancing attendance in theaters for performances and consequently, ticket sales, is to provide lounger type massage machines, also commonly referred to as massage chairs, in lieu of or in combination with existing seats used in these settings. For sake of brevity, referral to theater herein means a building, room, cinemas, or outdoor structure having a row of seats, tiers of seats, seat around or behind a table used for film viewing, presentation of plays or dramatic performances, operas, concerts, sports, demonstrations, exhibitions, and holding of social gatherings, meetings, seminars, lectures, and the like. Activities within a theater as illustrated and enumerated above is collectively referred to as performance. The availability of massage chairs in theaters appeals to the fast pace modern world because a viewer can have better use of one's leisure time by being able to simultaneously relax one's mind and tone one's body thereby momentarily escaping reality, both mentally and physically. It may also offer a means to overcome the temptation of munching snacks while waiting or while viewing for the performance, an appeal to those who keep watch of their diet. Availability of massage chairs will also differentiate one theater from the other and will additionally attract even those loyal home video viewers who may not have massage chairs at their home.

Currently, theaters implement seats with no massage functionality, herein referred to as conventional chairs. Current seats vary, but in cinemas, most have seat bottoms which retract upwards when there is no occupant to allow extra walking room between each aisle of seats and which pushes down and outward with the weight of the viewer.

It is therefore an object of this invention to enhance ticket sales by providing massage chairs in theaters which enhances one theater from the other.

It is also an object of this invention to improve attendance and attentiveness in lectures, seminars, and meetings by providing massage chairs that will tone the body and keep an attendee relaxed thereby improving the attention span.

It is a further object of this invention to provide attendees, patrons and viewers the opportunity to tone one's body while viewing a performance, at intermissions, before or after performances thereby making better use of one's time.

### BRIEF DESCRIPTION OF THE DRAWING

FIG. 1 shows a massage chair with controls on a side arm.

FIG. 1A shows a plan view of a control panel.

FIG. 2 show a hand held control panel electrically connected to a massage chair.

FIG. 2A show a wireless hand held control panel used with a massage chair.

### SUMMARY OF THE INVENTION

The invention relates to the installation of massage chairs instead of conventional chairs in theaters to enhance ticket sales. For theaters that will not replace all seats with massage chairs, certain features of the massage chair and certain procedures are placed to ensure that only premium paying patrons, patrons that pay a higher entrance fee, can sit and use the massage chairs.

A massage chair having features useful in a theater setting comprises a massage chair convertible to a conventional chair performing a variety of functionalities; activation devices that are either fixed or electrically connected to the massage chair or located away from the massage chair but inside the theater that accepts either one of token, code, card, or currency for activation or are centrally controlled; a control panel having control buttons such as buttons, switches, function signal areas and the like for operating the massage chairs; and, various means for either temporarily or permanently disabling the massage chair. Both activation and operation may be controlled by the same control panel. The control panel can be a wireless hand held remote control device, a hand held device electrically connected to the massage chair, or a fixed device on a side arm of the massage chair. It is recommended to have a lighting device on the control panel especially if there would be instances when it will be operated in the dark. If desired, the massage chair can have audio connections so that messages, instructions, and warnings can be relayed to the user/premium patron.

The procedure for ensuring that premium patrons are the only customers using the massage chairs, comprises limiting the access to the massage chairs either by personally checking on the premium patron's ticket prior to seating at a massage chair, or by providing a code, token, or card to a premium patron upon payment which will be used to activate the chosen or assigned massage chair. It is preferable to choose an activating method from the above that can specifically activate only a particular massage chair such as the use of a code or an activating card. An activation brought about by central control can activate only a particular massage chair as it is assigned or chosen by the premium patron, as the case may be. The actual operation of the massage chair may be done manually or it can be programmed using computer technology prior to the start of the performance. A premium patron can start the massage chair anytime during the duration of activation which is usually a few minutes before and after the performance and during the performance. While activated, the premium patron can start or stop the massage chair at will and choose and change the functionalities and enhancements desired. To ensure that a premium patron stays for only one performance, the massage chairs are centrally disabled and reset for the next performance, preferably with an activation process that is unique to the next performance, that is, different from the previous performance.

### DETAILED DESCRIPTION OF THE INVENTION

To enhance ticket sales or encourage attendance, massage chairs 1 or lounger type massage machines are installed in theaters either to replace the entire seating or a portion of the seatings. The massage chair is powered electrically. Theaters subdivided into separate individual theater rooms may opt to install massage chairs in one or some of the theater rooms while keeping the current seats on the others. For example, a movie house or cinema with twelve individual movie theaters can implement massage chairs as seating in one or a few of these individual movie theaters within the same movie house.

This method of implementing massage chairs as theater seats differentiates and enhances a theater from its competitors with conventional seats. Massage chairs likewise offers a good marketing tool for the theater owner/operator when attendees, patrons or viewers, hereinafter also referred to simply as patron, talk about it to friends and associates. The massage chairs come in different brands and functionalities. A few of the many providers of massage chairs are OSIM International Ltd. of Singapore, Panasonic Personal Care Products of Kodoma City, Osaka, Japan, Matsushita Electronic Industrial Co., Hsin Hao Health Materials Co., Ltd., and Fuhsing Hsiang, Chonghua, Taiwan. Each provider may or may not offer the same types of functionalities and enhancements. A theater owner may choose from the different varieties available. A non-comprehensive list of functionalities or types of massages are tapping massage, kneading massage, rolling massage, complete massage, vibration massage, floating vibration, sensitive massage, point, partial, or full body massage, automatic massage program, shiatsu massage, back massage, seat and calf massage, pre-programmed massage, and neck massage. The functionalities of the massage chairs may incorporate other enhancements such as, warmers, ergonometric design, intensity control, automatic reclining, automatic timers, soft cushioned seats, massage speed, width and length flexibility, etc.

The massage chair 1 may be bolted down to the floor of the theater or kept unbolted if it is of such weight that will keep the massage chair from moving away from its original position during operation or during an earthquake or similar situation. These massage chairs may be arranged according to the owner's discretion, for example in columns and rows, behind a table, around a table, etc.

In a lounger type massage machine or massage chair, the patron user usually sits down on the seat with his back reclined against the back support to provide maximum reach to all parts of the body.

Increase in revenues brought about by the massage chairs are realized through increased pricing or increased attendance. A patron wishing to sit on a massage chair to get a massage while in the theater will pay a premium price, herein identified as premium patron, compared to the regular patron, those sitting at the conventional seats. Increased revenues due to increased attendance will require all seats to be massage chairs because the purpose is to sell more tickets without necessarily increasing the entrance fee. Increase revenues through increased pricing may or may not need all seats to be massage chairs. When all seats in a theater are massage chairs, increase in revenue is realized by simply increasing the entrance fee. Because all the seats are massage chairs, no special modifications on the activation of the massage chairs are needed and the access procedure need not be controlled. In the situation where conventional seats are not fully replaced with massage chairs, however, it is recommended to have massage chairs that converts to conventional chairs to capture possible overflow of regular patrons when there are not enough premium patrons to fill the section of massage chairs. This would prevent having vacant seats that could have been offered at the regular price. If some unconvertible massage chairs do not get fully occupied but could have been sold at regular price, this could even result in a potential loss rather than a gain in revenue. Convertible massage chairs provide the flexibility and capability of utilizing all seats, if called for by the situation.

Additionally, although the plain installation of massage chairs in theaters may be sufficient to entice home viewers to go to the theaters, central to the full realization of increasing the revenue on theaters partially equipped with massage chairs rests on the type of process implemented on three basic areas: access, chair activation, and chair control. One need not implement all processes in these three areas, but one or a combination of a few may suffice.

Access is the first safeguard to consider. Only premium patrons should be able to sit at the massage chairs. For theaters with only a section equipped with massage chairs, access can be controlled by the customary process of having an usher check on the type of ticket purchased to ensure that only premium patrons enter the section. This process requires additional manpower which equates to a higher overhead cost. Restriction without the need of additional manpower can be realized by a well managed activation process.

One process is a combination of restricted access and activation. Access is obtained by advanced prepaid reservation or paying at the door. Advanced reservations for the massage chairs may be offered by prepayment to guarantee seating and to give a premium patron the opportunity to select a particular seat location. The premium patron after prepayment by phone through credit card or by cash/check through mail or by personal delivery, simply chooses the desired seat location by stating the row and seat number and if this is available, a code such as a confirmation number is given. If the seat is already taken, the premium patron is asked to choose another seat. Premium patrons paying at the door are also given a code/confirmation number after payment. At the time of the performance, to activate the massage chair, the premium patron simply enters the code or confirmation number on either a control panel 2 fixed on a side arm of the massage chair or on a hand held control panel 3 depending upon the type of control used. The code need not be a number or a series of number but any type of coding can be used. The use of other activation process aside from entering the confirmation on the control panels 2 or 3 are also available. To identify a prepaid reserved seat, this will have a reserve sign or a lit button, recommended to be red in color, to apprise a premium patron coming in without advance reservation not to occupy the seat. A pay at door premium patron need not be assigned a specific seat but may come in on a first come first serve basis and occupy those massage chairs that are not previously reserved or taken. The pay at door or walk in premium patrons may also be given assigned seats, if desired. The advantage of requesting advanced reservation is to be able to convert some massage chairs to conventional chairs ahead of time if the number of premium patrons is not enough to occupy all the massage chairs. To maximize benefit and avoid one premium patron from occupying another premium patron's seat, a particular massage chair should only be activated by a particular code or confirmation number as the case may be.

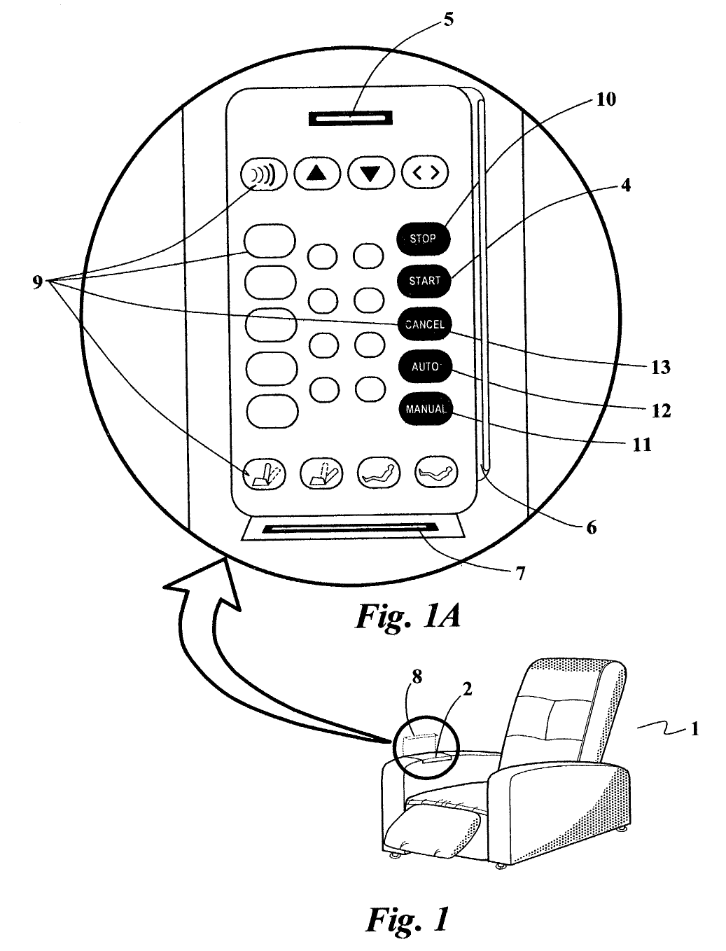

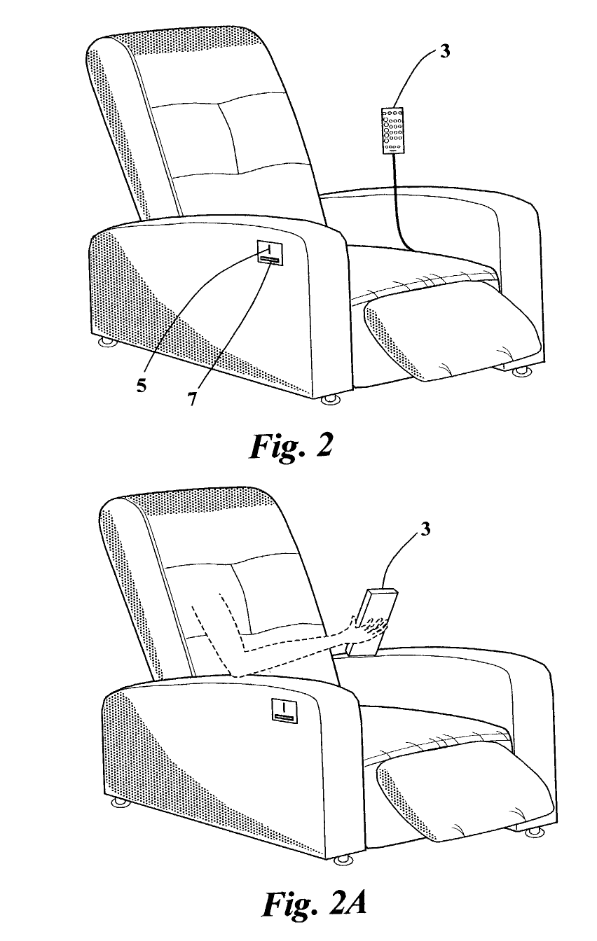

Activation, as used here, means providing electrical power to a particular massage chair to enable a premium patron to start the massage chair functionality when desired. Activation does not start the actual operation of the massage chair. The functionalities are started from a control panel. To get a massage, the premium patron still has to start the start button 4 after choosing the desired massage functionality. Activation may be brought about by several means. Examples applicable to a theater setting are: a) through a central control which activates a seat as the particular seat number is taken by a premium patron; b) by giving a token for the premium patron to slip into an activating slot 5 for activation; c) by providing a code such as the confirmation number mentioned above to press or enter; or, d) by giving an access card that have activating means such as a magnetic strip or a smart card that a premium patron can swipe or enter into a card reader 6 of an activating device. For c) and d) above, to avoid switching of chairs, it is recommended to employ a similar technology such as those used in hotel rooms where the codes or access cards will activate only a particular chair. Examples b) and d) activation may be brought about by a regular patron paying in cash, coin or paper currency, or credit card through payment activation devices such as those used in hotels as mentioned above, in telephones, slot machines, copy machines, vending machines and the like, installed on the massage chairs, usually fixed at the side arm on the same or opposite that used for refreshments such as that shown in FIG. 1. It can also be a separate unit, a hand held activation device electronically connected with or without wiring to the massage chair such as that shown in FIGS. 2 and 2A. Activation may also be provided by installing an activation machine in a location inside the theater where a premium patron activates a particular seat location through the various mean mentioned above, by token, card, etc. The activating slot 5 may be used for both the token and the coin and the card reader 6 can also be used for the credit card payment. A paper currency acceptor 7 can also be provided if paper money aside from coin can be used to pay for activation. Massage chairs activated by currency (coin or paper) or credit card allow more flexibility because a regular patron can change his/her mind and decide to get a massage while already inside the theater without the need of going back to the front office. At this point, the patron simply pays for the massage on a timed basis, for example, a dollar for ten minutes, etc. This type of massage chairs are preferably identified or located at a certain section of the theater to differentiate them from those massage chairs that are activated throughout an entire performance. However, if a regular patron changes his/her mind and wants to convert to a premium patron where the massage chair is activated throughout one performance, then he/she needs to go back to the front office to effect the conversion of status. After activation, a premium patron may not transfer to another seat without asking permission from the owner, operator, or usher. To control these occurrences, premium patrons should be forewarned that transferring will be allowed only for emergency or for good cause. If a transfer has been allowed, only the owner, operator or usher can prematurely deactivate the seat/massage chair while the massage chair is activated and activate another seat either by a key, by punching a secret code or pin number, or by swiping a special card. The use of the same or different codes, keys or cards for activation and deactivation is at the discretion of the theater owner/operator. Activation by central control requires an operator who will activate a massage chair as it is assigned or chosen by a premium patron depending upon the process implemented by the theater owner or operator. The duration of the activation is usually timed for one entire performance, as stated above except for those massage chairs that are purchased by time. During the entire period of activation, the massage chair can be turned off or on at will at any time interval desired, resumed anytime during the duration of activation, and the type of chosen massage functionality and enhancement can likewise be changed at the discretion of the premium patron. After the performance or shortly after but before the next performance, all massage chairs will be disabled centrally whether or not a premium patron has used the massage chair. Disable means turning off the power from the massage chairs and it is recommended at this point to reprogram or reset the chosen process for activating these chairs to get them ready for the next performance. Examples are changing the activation code, issuing a new set of activation cards, accepting only tokens for a particular performance, etc. This feature will prevent a stay over premium patron, patron from a previous performance, to use the massage chair after the paid for performance is over. A central capability of turning off the massage chairs is also a safety feature to disable these chairs in case of earthquake, fires, and other emergency situations. A warning or message should be given to the premium patron on the usage and duration of the massage privileges. A screen message before the actual performance can also be employed to convey or augment this warning or message.

All massage chairs are equipped with personalized controls to operate the chairs either by a hand held wireless remote control 3, a hand held control 3 electrically connected to the massage chair as shown in FIGS. 2 and 2A, or by a fixed control 2 usually located at the same side arm of the massage chair where the activation device is located as shown in FIG. 1. The activation mechanism may be physically integrated with the control mechanism thereby allowing their respective operations from a single control panel as shown in FIG. 1A or separated from the activation mechanism. For a massage chair activated through a central control, the control panel is used only for operating the massage chair. Although the activation mechanism may be separated from the control mechanism, herein, reference to control panel covers both the activation mechanism and the control mechanism. The control panel fixed at a side arm is recommended to have a cover 8 to prevent a patron from accidentally operating or touching the buttons or switches. Instead of button or switches, a function signal area on the control panel visibly bordered which are triggered by pressing can also be used. For simplicity, these are collectively referred to as control buttons or buttons 9. Likewise, the word control panel covers the different forms stated above, hand held or fixed. The control panel has different control buttons for the different functionalities and activation mechanisms but some control buttons may be used by both mechanisms, for example, the buttons used for entry of a code for activation may also be used for choosing a certain functionality once the massage chair has been activated. The operation of the control buttons on the control panel allows the premium patron to start 4 or stop 10 the desired massage functionality after the massage chair has been activated. A chosen functionality can be changed anytime before selecting the start button by selecting a different button for a different functionality. The chosen functionality or type of massage will not start until the start button 4 is selected. If the massage chair is going to be used for theater performances where lights will be turned off during the performance, the premium patron should be able to operate the massage chair in the dark, consequently, the control panel for these applications should have illuminated buttons and/or instructions or have lighting devices illuminate the control panel such as a light bulb that can be turned on or off. The technology of providing illuminated buttons or instructions or lighting a desired area are known in the art. The design of the buttons 9 is left to the discretion of the theater owner/operator, it may have letters, numbers, pictures, words, different colors, or a combination of these. The operation of the different types of-control panels may be manual or it can be operated both manually and through computer technology. A patron selects either the manual button 11 or the auto button 12 depending upon which type of operation is preferred. The auto button once selected, allow premium patrons to preprogram the sequence of operation of the massage chair according to their wishes by using the appropriate buttons on the control panel for programming for the entire duration or part of the duration of the activation period of the massage chair. A premium patron usually does this prior to the start of the performance, that is stating the time to start, the type of massage, the duration, the time to start the next massage functionality, the duration, the speed, etc. Control panels that can be programmed should also have capability of stopping or erasing the program after the start of the massage by selecting the cancel button 13 and then go to manual by selecting the manual button 11 then proceeding by selecting the desired button for the designated massage functionality or to simply stop. Once the program is erased or stopped, control becomes manual. The control panel may also have another button, by design, that can reinstate the latest program, if desired. A button for a preset program may also be provided but this does not give the flexibility of designing one's own sequence and types of massages desired. Control buttons for the enhancement functionalities such as intensity, duration, width, speed, and others are also provided, in addition to the type of massage. Buttons for go/start 4 and stop 10 are recommended to be lit or colored with green and red, respectively, to conform with what the public has associated these colors with. For buttons using letters, it is preferable to associate the letters with the first letter of the function, for example, B for back massage, C for complete massage and so on.

The control panels may also have audio connections, if desired by the theater owner/operator for conveying instructions, messages and warnings. Each button is associated with a given function such that when one selects a button, a voice will state the function requested. If the function stated is desired, the premium patron simply selects the start button to initiate the function. For controls with audio connections, a headset may be provided at the seat. Audio capabilities help prevent a premium patron from starting an undesired function. Additionally, audio connections can also give a short explanation or cautionary words on the chosen function to inform the premium patron and allow a change of mind before starting the requested function. The latter function, however, is not recommended to be availed to when the performance is already on-going as it will distract the premium patron from the performance. Like the control panel without audio connection above, a chosen functionality can be changed anytime before selecting the start button by selecting a different button. One can select one button at a time and listen to each one to know the function assigned to a particular button before operating the massage chair. Controls with audio connections can employ simpler buttons such as numbered buttons because an audio will state the function.

After access to the massage chair, to operate, one simply activates the chair and if the massage chair has a programming capability, preprograms the desired massage including time, speed, duration and the like, if desired. For manual operation, one selects the manual button 11, if available, or simply operates the specific buttons for the desired function and enhancements, and then selects the go or start button 4 whenever one desires to start the massage. It is understood that a premium patron is not limited to one type of function and enhancement but several changes can be made as desired by repeating the process of selecting the stop button 10, selecting another button 9 for another function and then selecting the start button 4 again during the duration of activation paid for by the premium patron. In a preprogrammed massage, these types of functions and enhancements are programmed in ahead of time. It is recommended to have no time requirement between choosing or programming the function and starting the actual function or massage to allow the premium patron to set or program the buttons while the theater is still lit as well as to have the option to start the massage at will anytime prior to the end of the performance or activation period or to have a rest between massages while the performance is going on. The ability to operate the massage chair terminates once the duration of activation is over.

For performances and functions with variable times such as in lectures, demonstrations, exhibits and the like, a premium patron may want only a few minutes of massage. For these situations, activation and massage are preferably purchased in increments of time, for example, $1.00 for 10 minutes, $1.50 for 20 minutes, etc. Payments for activation can be made in the same manner enumerated above.

To protect an owner from liability stemming from the use of massage chairs by patrons who should not or can not handle a massage, it is recommended to post bold notices that it is patron's responsibility to check with their doctor if it is safe for them to have a massage. Audio enhancements, if available, should announce this at the onset before starting a massage.

While the embodiment of the present invention has been described, it should be understood that various changes, modifications and adaptations may be made therein without departing from the spirit of the invention and the scope of the appended claims. Those skilled in the art will recognize that other and further variations of the features presented herein are possible. The scope of the present invention should be determined by the teachings disclosed herein, the appended claims and their legal equivalents.

I claim:

1. A massage chair useful in theaters, comprising:
a massage chair performing a variety of functionalities, the massage chair convertible to a conventional chair;
means for providing power to the massage chair;
means for individually activating the massage chair, the activating means selected from the group consisting of central control, token, code, card and currency;
means for controlling the operation of the massage chair; and,
means for disabling the massage chair.

2. The massage chair of claim 1 further comprising means for programming the operation of the massage chair.

3. The massage chair of claim 1 wherein the activation is provided by a device fixed at a side arm of the massage chair.

4. The massage chair of claim 1 wherein the activation device is a hand held device.

5. The massage chair of claim 1 wherein the activation device is an activation machine located inside the theater.

6. The massage chair of claim 1 wherein the means for controlling the operation of the massage chair is a control panel having control buttons and lighting means to illuminate the control buttons in the dark.

7. The massage chair of claim 6 wherein the control panel is a wireless hand held remote control device, a hand held device electrically connected to the massage chair, or a fixed device on a side arm of the massage chair.

8. The massage chair of claim 7 wherein the fixed device on the side arm of the massage chair has a cover to prevent inadvertent operation of the buttons, switches, and function signal areas.

9. The massage chair of claim 1 wherein the means for activating the massage chair is physically integrated with the means for controlling the operation of the massage chair.

10. The massage chair of claim 9 wherein the activating means is operated from the same control panel controlling the operation of the massage chair.

11. The massage chair of claim 1 further comprising means for delivering messages related to the operation of the massage chair.

12. The massage chair of claim 1 further comprising means for prematurely deactivating the massage chair while the massage chair is activated.

13. A method of enhancing ticket sales in theaters comprising installing massage chairs for seating inside the theaters, the massage chairs having different functionalities.

14. A method of enhancing ticket sales in theaters, comprising:
installing massage chairs for seating inside the theaters;
limiting access to the massage chairs to premium patrons;
activating the massage chair for a duration of time;
operating the massage chair; and,
disabling the operation of the massage chair.

15. The method of claim 14 further comprising programming a desired sequence of operation of the massage chair.

16. The method of claim 14 wherein access is by advanced prepaid reservation, the advanced prepaid reservation providing a confirmation number.

17. The method of claim 16 wherein the confirmation number activates only a particular chair.

18. The method of claim 14 wherein the activation is through a central control which activates a seat as the particular seat is taken.

19. The method of claim 14 wherein the activation is through entry of a code.

20. The method of claim 14 wherein the activation is by slipping a token or coin through an activating slot.

21. The method of claim 14 wherein the activation is by swiping or entering a card into a card reader.

22. The method of claim 14 wherein the activation is by payment through a paper currency acceptor.

23. The method of claim 14 further comprising preventing a premium patron from transferring from a chosen or assigned massage chair to another massage chair after activation of the chosen or assigned massage chair.

24. The method of claim 14 wherein operating the massage chair allow changing a chosen functionality, turning the massage chair on or off at will and resuming operation anytime during the duration of activation of the massage chair.

25. The method of claim 14 further comprising centrally resetting the activation process of the massage chairs after disabling the massage chair between performances.

26. The method of claim 25 wherein the massage chairs are activated with a chosen process unique to the next performance.
